(19) United States
(12) Patent Application Publication
(10) Pub. No.: US 2026/0256108 A1
(43) Pub. Date: Sep. 3, 2026

(54) ANIMAL LITTER

(71) Applicant: Givaudan SA, VERNIER (CH)

(72) Inventors: Guang-pian YU, Shanghai (CN); Lin Mei HE, Shanghai (CN)

(21) Appl. No.: 19/474,348

(22) PCT Filed: May 2, 2024
(86) PCT No.: PCT/EP2024/062053

§ 371 Date: Oct. 10, 2025

(30) Foreign Application Priority Data
May 6, 2023 (WO) PCT/CN2023/092490

(51) Int. Cl. A01K 1/015

(52) U.S. Cl. CPC A01K 1/0155

(57) ABSTRACT

An animal litter comprising (a) an animal litter base and (b) a particulate absorptive matrix to which fragrance has been added, the fragrance being characterised by (a) having weight proportions of top, middle and base notes of respectively 35-80, 10-40 and 5-25% (b) components with a C log P value of less than 1.5 comprising 3% maximum of the fragrance, and (c) being substantially free from water-miscible solvents.

The litter is resistant to the heating step often used in litter preparation and delivers an undiminished malodour counteraction effect.

This disclosure relates to an animal litter and to a method of making it.

Animal litters, notably for cats, are well known and commonly available. Their purpose is to absorb urine and fecal matter. As such, the litter consists of a suitably absorptive matrix, frequently based on a porous cellulosic or mineral (typically clay) material. Ideally, the litter should also mask the unpleasant odour of animal eliminative products, especially in the case in which the litter remains unchanged for some time. The traditional method of achieving this is by the addition of fragrance to the matrix. This can be achieved by simple addition of fragrance to the basic matrix material, or it can be a more sophisticated encapsulated approach, such as those described in International Publications WO 2006/105680 and WO 2023/030855.

In some litter preparation processes involving extrusion and granulation, the raw materials are mixed with water (about 10% by weight of the total mixture) to aid the extrusion. This water must then be substantially removed, which involves heating the granulated material. This has the problem of removing not only the water, but also a substantial proportion of the fragrance, thus reducing the effectiveness of the litter. There are relatively few litter compositions that can effectively deal with this.

It has now been found that an acceptable level of malodour counteraction performance can be achieved by means of a particular formulation. There is therefore provided an animal litter comprising (a) an animal litter base and (b) a particulate absorptive matrix to which fragrance has been added, the fragrance being characterised by (a) having weight proportions of top, middle and base notes of respectively 35-80, 10-40 and 5-25% (b) components with a C log P value of less than 1.5 comprising 3% maximum of the fragrance, and (c) being substantially free from water-miscible solvents.

There is additionally provided a method of preparing an animal litter comprising a malodour-counteracting fragrance, comprising the steps of blending the components, adding sufficient water to permit extrusion, extruding and granulating the mixture and then drying the granulates, characterised in that the fragrance is added in the form of a particulate matrix in which the fragrance is absorbed, and in that the fragrance is as hereinabove defined.

In particular embodiments, the weight proportions of top, middle and base notes are, respectively 40-70, 15-35 and 8-20%, more particularly 45-60%, 25-35% and 10-20%, more particularly 50-60, 25-30% and 10-15%.

By “animal litter base” is meant the basic absorptive material that is used to absorb the waste. It is typically a cellulosic or mineral material, such as tofu, wood particles, cellulosic materials such as paper and absorptive minerals such as bentonite.

The particulate absorptive matrix in which the fragrance is absorbed, prior to its being added to the litter base may be any suitable particulate material that has the ability to absorb fragrance. Non-limiting examples include maltodextrin, calcium carbonate, beta-cyclodextrin, bentonite, talcum powder, modified starches such as Hi-Cap™ 100, sodium sulfate, sodium starch octenylsuccinate such as Capsul™ E, fumed silica such as Aerosil™ 200, and mixtures thereof. Particular examples are talcum powder and beta-cyclodextrin.

The term C log P refers to the calculated logarithm of the octanol/water partition coefficient and is a commonly-used parameter in the fragrance industry. There are a number of methods of calculating C log P value, the one used in this disclosure being that calculated by the method of Daylight Chemical Information Systems, Inc, USA, and described in the publication:
https://www.daylight.com/dayhtml/doc/clogp/

The terms “top, middle and base notes” are well known to perfumers, being a reflection of the volatility of the fragrance ingredients. In a typical fragrance, the respective weight proportions of top, middle and base notes are respectively 15-25%, 30-50% and 30-50%. While these proportions are not rigid barriers and it is possible to work outside them, depending on the olfactory profile desired, it is generally known that moving too far outside will result in an unbalanced formulation that does not deliver a desirable olfactory effect. In the case of the present disclosure, formulating substantially outside these normally-accepted limits in combination with the specified C log P parameter and the absorption into a particulate matrix delivers, in this particular use, highly beneficial results.

Top note fragrance ingredients may include, but are not limited to: allyl heptanoate (for example ALLYL OENANTHATE), (Z)-hex-3-en-1-yl methyl carbonate (for example LIFFAROME™), pentyl butanoate (for example AMYL BUTYRATE), 2,6-dimethylhept-5-enal (for example MELONAL™); 3-methylbutyl butanoate (for example ISOAMYL BUTYRATE), benzaldehyde, (4S)-4,7,7-trimethyl-6-thiabicyclo[3.2.1]octane (for example CORPS PAMPLEMOUSSE), hexyl acetate (for example ACETATE C 6 HEXYLIC), (Z)-hex-3-en-1-yl acetate (for example HEXENYL-3-CIS ACETATE), 4-methylpent-4-en-2-yl 2-methylpropanoate (for example ISOPENTYRATE); 2-methyl-4-propyl-1,3-oxathiane (for example OXANE™), 3-methylbut-2-en-1-yl acetate (for example PRENYL ACETATE), 6-methylheptan-3-one (for example ETHYL ISOAMYL KETONE), ethyl 2-methylpentanoate (for example MANZANATE™); heptan-2-one (for example METHYL AMYL KETONE), 3-methylbutyl acetate (for example ISOAMYL ACETATE), ethyl 2-methylbutanoate (for example ETHYL METHYL-2-BUTYRATE), and ethyl butanoate (for example ETHYL BUTYRATE); decanal (for example ALDEHYDE C 10 DECYLIC), (E)-dec-4-enal (for example DECENAL-4-TRANS), 3,7-dimethyloct-6-enal (for example CITRONELLAL), 1-phenylethanethiol (for example ANJERUK)™, 6,6-dimethoxy-2,5,5-trimethylhex-2-ene (for example METHYL PAMPLEMOUSSE), nonanal (for example ALDEHYDE C 9 NONYLIC), 4,7-dimethyloct-6-en-3-one (for example DIMETHYL OCTENONE), octanal (for example ALDEHYDE C 8 OCTYLIC); 3,5,5-trimethylhexanal (for example ALDEHYDE C 9 ISONONYLIC); 1-methyl-4-(prop-1-en-2-yl)cyclohex-1-ene (for example DIPENTENE, LIMONENE), 1-methyl-4-(propan-2-ylidene)cyclohex-1-ene (for example TERPINOLENE), heptanal (for example ALDEHYDE C 7 HEPTYLIC); (3E,5Z)-undeca-1,3,5-triene (for example UNDECATRIENE), (2E,6Z)-nona-2,6-dienal (for example NONADIENAL™); 2,4-dimethylcyclohex-3-enecarbaldehyde (for example TRICYCLAL), 4-vinylcyclohex-1-enecarbaldehyde (for example SHISOLIA™), 2,4-dimethylcyclohex-3-enecarbaldehyde (for example CYCLAL C™), 4-methyl-2-(2-methylprop-1-en-1-yl)tetrahydro-2H-pyran (for example ROSE OXIDE CO); (Z)-hex-3-en-1-ol (for example HEXENOL-3-CIS), 7-methyl-3-methyleneocta-1,6-diene (for example MYRCENE), hexan-1-ol (for example ALDEHYDE C 6 HEXYLIC); as 3,7-dimethylocta-1,6-dien-3-yl acetate (for example LINALYL ACETATE), (2S,4S)-1,7,7-trimethylbicyclo[2.2.1]heptan-2-yl acetate (for example BORNYL ACETATE), 2-(sec-butyl)cyclohexanone (for example FRESKOMENTHE™), (1S,2R,4R)-1,3,3-trimethylbicyclo[2.2.1]heptan-2-ol (for example FENCHYL ALCOHOL), 2-isopropyl-5-methylcyclohexanone (for example ISOMENTHONE DL™), (2S)-1,3,3-trimethylbicyclo[2.2.1]heptan-2-yl acetate (for example FENCHYL ACETATE), 2,6-dimethyloct-7-en-2-ol (for example DIMYRCETOL), (1S,4S)-1,7,7-trimethylbicyclo[2.2.1]heptan-2-one (for example CAMPHOR), 2-isopropyl-5-methylcyclohexanone (for example MENTHONE™); 1-methyl-4-propan-2-ylcyclohexa-1,4-diene (for example TERPINENE GAMMA), 1-methyl-4-propan-2-ylbenzene (for example CYMENE PARA); (1s,4s)-1,3,3-trimethyl-2-oxabicyclo[2.2.2]octane (for example EUCALYPTOL), 2,2,6-trimethyl-6-vinyltetrahydro-2H-pyran (for example LIMETOL™), 6,6-dimethyl-2-methylenebicyclo[3.1.1]heptane (for example PINENE BETA), 2,6,6-trimethylbicyclo[3.1.1]hept-2-ene (for example PINENE ALPHA); benzyl acetate (for example BENZYL ACETATE); methyl 2-hydroxybenzoate (for example METHYL SALICYLATE), 3,7-dimethyloctan-3-ol (for example TETRAHYDRO LINALOOL), (Z)-3,4,5,6,6-pentamethylhept-3-en-2-one (for example KOAVONE™), 2,6-dimethyloct-7-en-2-ol (for example DIHYDRO MYRCENOL), 3,7-dimethylocta-1,6-dien-3-ol (for example LINALOOL), 2-(2-hydroxypropan-2-yl)-5-methylcyclohexanol (for example GERANODYLE™); 1-phenylethanone (for example ACETOPHENONE), 2,6-dimethylheptan-2-ol (for example DIMETOL), methyl benzoate (for example METHYL BENZOATE); 1-methoxy-4-methylbenzene (for example CRESYL METHYL ETHER PARA); and mixtures thereof.

In a particular embodiment, at least 50% by weight of the total top note ingredients have a flash point below 150° C. and a vapor pressure above 0.2 ug/L. In a further particular embodiment, all top note ingredients comply with this requirement.

Middle note fragrance ingredients include, but are not limited to: methyl non-2-ynoate (for example METHYL OCTYNE CARBONATE), 2-phenethyl isobutanoate (for example PHENYL ETHYL ISOBUTYRATE), 5-isopropyl-2-methylphenol (for example CARVACROL), (E)-1-methoxy-4-(prop-1-en-1-yl)benzene (for example ANETHOLE), 3,7-dimethyloctan-1-ol (for example PELARGOL™), (3aS,4S,7R,7aS)-ethyl octahydro-1H-4,7-methanoindene-3a-carboxylate (for example FRUITATE™), (E)-3,7-dimethylocta-2,6-dien-1-yl acetate (for example GERANYL ACETATE), (Z)-3,7-dimethylocta-2,6-dien-1-ol (for example NEROLEX™), 3,7-dimethyloct-6-en-1-yl formate (for example CITRONELLYL FORMATE), 2-(2,4-dimethylcyclohexyl)pyridine (for example ZINARINE); oxydibenzene (for example DIPHENYL OXIDE), 2-methylundecanal (for example ALDEHYDE C 12 MNA), bicyclo[2.2.2]oct-5-ene-2-carboxaldehyde (for example MACEAL™), (3aR,6S,7aS)-3a,4,5,6,7,7a-hexahydro-1H-4,7-methanoinden-6-yl acetate (for example JASMACYCLENE™), (Z)-3,7-dimethylocta-2,6-dien-1-yl acetate (for example NERYL ACETATE), (E)-1-(2,6,6-trimethylcyclohexa-1,3-dien-1-yl) but-2-en-1-one (for example DAMASCENONE™), (E)-5-methylheptan-3-one oxime (for example STEMONE™), (2-(isopentyloxy)ethyl)benzene (for example ANTHER), 2-(4-methylcyclohex-3-en-1-yl)propan-2-ol (for example LINDENOL™), 1-(cyclopropylmethyl)-4-methoxybenzene (for example TOSCANOL™), (Z)-4,11,11-trimethyl-8-methylenebicyclo[7.2.0]undec-4-ene (for example CARYOPHYLLENE™), 2-phenylethanol (for example PHENYL ETHYL ALCOHOL); of ingredients having equilibrium headspace concentration from 301 μg/l to about 400 μg/l, such as 4-phenylbutan-2-one (for example BENZYL ACETONE), 1-(3,3-dimethylcyclohexyl) ethanol (for example CYCLADEMOL™), 2-(2-mercaptopropan-2-yl)-5-methylcyclohexanone (for example CORPS CASSIS), 2-(4-methylcyclohex-3-en-1-yl)propan-2-ol (for example TERPINEOL™), 2-(tert-pentyl)cyclohexyl acetate (for example CONIFERAN™), 2,4,6-trimethyl-4-phenyl-1,3-dioxane (for example FLOROPAL™), 3,7-dimethyloct-6-en-1-yl acetate (for example CITRONELLYL ACETATE), 2,4-dimethyl-4-phenyltetrahydrofuran (for example RHUBAFURAN™), (E)-undec-9-enal (for example ALDEHYDE ISO C 11), 4-isopropylcyclohexanol (for example FOLROSIA), undecanal (for example ALDEHYDE C 110 UNDECYLIC), undecan-2-one (for example METHYL NONYL KETONE), 2-methyl-1-phenylpropan-2-yl acetate (for example DIMETHYL BENZYL CARBINYL ACETATE), (1S,2S,4S)-1,7,7-trimethylbicyclo[2.2.1]heptan-2-ol (for example BORNEOL CRYSTALS), 2-phenethyl acetate (for example PHENYL ETHYL ACETATE), 2-(4-methyl-1-cyclohex-3-enyl)propan-2-ol (for example TERPINEOL ALPHA), 4-(tert-butyl)cyclohexyl acetate (for example PARA TERT BUTYL CYCLOHEXYL ACETATE), 2-methyl-1-phenylpropan-2-ol (for example DIMETHYL BENZYL CARBINOL), 3-tert-butyl-cyclohexyl acetate (for example CYPERATE); (E)-3,7-dimethylocta-2,6-dienal (for example CITRAL TECH), 4-isopropylbenzaldehyde (for example CUMINIC ALDEHYDE), phenylmethanol (for example BENZYL ALCOHOL), decanenitrile (for example DECANONITRILE), 3,7-dimethyloct-6-enenitrile (for example CITRONELLYL NITRILE), (E)-3,7-dimethylocta-2,6-dien-1-yl formate (for example GERANYL FORMATE), 2-(4-methylcyclohex-3-en-1-yl)propan-2-yl acetate (for example TERPINYL ACETATE), undec-10-enal (for example ALDEHYDE C 11 UNDECYLENIC), benzyl propionate (for example BENZYL PROPIONATE), p-cresol (for example PARA CRESOL); ethyl 2-hydroxybenzoate (for example ETHYL SALICYLATE), octan-1-ol (for example ALCOHOL C 8 OCTYLIC), 4-(tert-butyl)cyclohexanone (for example PARA TERT BUTYL CYCLOHEXANONE), 2-(tert-butyl)cyclohexanol (for example VERDOL™), 3-phenylbutanal (for example TRIFERNAL™), (E)-3,7-dimethylnona-1,6-dien-3-ol (for example ETHYL LINALOOL), (2E,6Z)-nona-2,6-dienenitrile (for example VIOLET NITRILE), 2-methyl-5-(prop-1-en-2-yl)cyclohex-2-enone (for example CARVONE™ LAEVO); allyl 2-(isopentyloxy)acetate (for example ALLYL AMYL GLYCOLATE), 2-methyldecanal (for example ALDEHYDE C 11 MOA), 2-(4-methylcyclohexyl)propan-2-ol (for example DIHYDRO TERPINEOL), 2,6-dimethyloctan-2-ol (for example TETRAHYDRO MYRCENOL), 2-pentylcyclopentanone (for example QUINTONE™), 6-methoxy-2,6-dimethylheptanal (for example METHOXY MELONAL), 1-phenylethyl acetate (for example GARDENOL™), 2-(4-methylcyclohexyl)propan-2-yl acetate (for example MENTHANYL ACETATE), 1-(p-tolyl) ethanone (for example METHYL ACETOPHENONE), 2-(tert-butyl)cyclohexyl acetate (for example AGRUMEX™), ethyl 2-(2-methyl-1,3-dioxolan-2-yl)acetate (for example FRUCTONE), 2-methylpentyl 2-methylpentanoate (for example PERANAT™), p-tolyl acetate (for example CRESYL ACETATE PARA); and mixtures thereof.

Base note fragrance ingredients include, but are not limited to: methyl 2,4-dihydroxy-3,6-dimethylbenzoate (for example EVERNYL™), 3,8,8,11a-tetramethyldodecahydro-1H-3,5a-epoxynaphtho[2,1-c]oxepine (for example AMBERKETAL™), 3-((1R,2S,4R,6R)-5,5,6-trimethylbicyclo[2.2.1]heptan-2-yl)cyclohexanol (for example SANDELA CONCENTRATED), 2-(2-(3,3,5-trimethylcyclohexyl) acetyl)cyclopentanone (for example DIONE™), (4aR,5R,7aS,9R)-Octahydro-2,2,5,8,8,9a-hexamethyl-4H-4a,9-methanoazuleno[5,6-d]-1,3-dioxole (for example AMBROCENIDE™), 5-(sec-butyl)-2-(2,4-dimethylcyclohex-3-en-1-yl)-5-methyl-1,3-dioxane (for example KARANAL™), 2,4-dimethyl-2-(5,5,8,8-tetramethyl-5,6,7,8-tetrahydronaphthalen-2-yl)-1,3-dioxolane (for example OKOUMAL), (1-methyl-2-((1,2,2-trimethylbicyclo[3.1.0]hexan-3-yl)methyl)cyclopropyl) methanol (for example JAVANOL™), ((1S,8aR)-1,4,4-trimethyl-2,3,3a,4,5,8-hexahydro-1H-5,8a-methanoazulen-6-yl) methanol (for example CEDRENOL™), 1-((1S,8aS)-1,4,4,6-tetramethyl-2,3,3a,4,5,8-hexahydro-1H-5,8a-methanoazulen-7-yl) ethanone (for example METHYL CEDRYL KETONE), 1-((1S,8aS)-1,4,4,6-tetramethyl-2,3,3a,4,5,8-hexahydro-1H-5,8a-methanoazulen-7-yl) ethanone (for example VERTOFIX COEUR™), 1-(2,2,6-trimethylcyclohexyl) hexan-3-ol (for example TIMBEROL™), (7,7,8,8-tetramethyloctahydro-2,3b-methanocyclopenta[1,3]cyclopropa[1,2]benzen-4-yl)methyl acetate (for example AMBORYL ACETATE), (E)-2-ethyl-4-(2,2,3-trimethylcyclopent-3-en-1-yl) but-2-en-1-ol (for example RADJANOL™), (1S,6R,8aR)-1,4,4,6-tetramethyloctahydro-1H-5,8a-methanoazulen-6-yl acetate (for example CEDRYL ACETATE CRYSTALS), 3a-ethyl-6,6,9a-trimethyldodecahydronaphtho[1,2-c]furan (for example GRISALVA™); 2-(3,8-dimethyl-1,2,3,4,5,6,7,8-octahydroazulen-5-yl)propan-2-yl acetate (for example GUAIYL ACETATE), 3-methoxy-5-methylphenol (for example ORCINYL 3™), (1-methyl-2-(((1R,3R)-2,2,3-trimethylcyclopentyl)methyl)cyclopropyl) methanol (for example PASHMINOL™), (E)-2-methyl-4-(2,2,3-trimethyl-1-cyclopent-3-enyl) but-2-en-1-ol (for example SANTACORE™), 3-methyl-5-(2,2,3-trimethylcyclopent-3-en-1-yl) pentan-2-ol (for example SANDALORE™), (4Z,8Z)-1,5,9-trimethyl-13-oxabicyclo[10.1.0]trideca-4,8-diene (for example CEDROXYDE™), (ethoxymethoxy)cyclododecane (for example BOISAMBRENE FORTE™), 4,8a,9,9-tetramethyldecahydro-1,6-methanonaphthalen-1-ol (for example PATCHOULI ALCOHOL), (E)-2-methyl-4-(2,2,3-trimethyl-1-cyclopent-3-enyl) but-2-en-1-ol (for example BRAHMANOL F™), 1-(2,3,8,8-tetramethyl-1,2,3,4,5,6,7,8-octahydronaphthalen-2-yl) ethanone (for example ISOCYCLEMONE E™), 1-(2,3,8,8-tetramethyl-1,2,3,4,5,6,7,8-octahydronaphthalen-2-yl) ethanone (for example ISO E SUPER™), 1-(1,2,8,8-tetramethyl-1,2,3,4,5,6,7,8-octahydronaphthalen-2-yl) ethanone (for example GEORGYWOOD™), N-ethyl-N-(m-tolyl)propionamide (for example AGARBOIS), 2,4a,5,8a-tetramethyl-1,2,3,4,4a,7,8,8a-octahydronaphthalen-1-yl formate (for example OXYOCTALINE FORMATE), (E)-3-methyl-5-(2,2,3-trimethylcyclopent-3-en-1-yl) pent-4-en-2-ol (for example EBANOL™), (E)-3,3-dimethyl-5-(2,2,3-trimethyl-3-cyclopenten-1-yl)-4-penten-2-ol (for example POLYSANTOL™), 1-((2-(tert-butyl)cyclohexyl)oxy) butan-2-ol (for example AMBER CORE), 7-methoxy-3,7-dimethyloctan-2-ol (for example OSYROL™); AMBERY/WOODY ingredients having equilibrium headspace concentration from about 51 μg/l to about 100 μg/l, such as (1R,2S,4R)-2′-isopropyl-1,7,7-trimethylspiro[bicyclo[2.2.1]heptane-2,4′-[1,3]dioxane] (for example BELAMBRE™), (1R,6S,8aS)-6-methoxy-1,4,4,6-tetramethyloctahydro-1H-5,8a-methanoazulene (for example CEDRYL METHYL ETHER), (Z)-1-(cyclooct-3-en-1-yl)propan-1-ol (for example FLORYMOSS™), 2′,2′,3,7,7-pentamethylspiro[bicyclo[4.1.0]heptane-2,5′-[1,3]dioxane] (for example SPIRAMBRENE™), 4-(1-ethoxyvinyl)-3,3,5,5-tetramethylcyclohexanone (for example KEPHALIS™); (1S,2R,5R)-2-ethoxy-2,6,6-trimethyl-9-methylenebicyclo[3.3.1]nonane (for example BOISIRIS™), 2-(tert-pentyl)cyclohexyl acetate (for example CONIFERAN™), 2-(sec-butyl)-1-methylcyclohexyl acetate (for example METAMBRATE™), 4-(tert-butyl)cyclohexyl acetate (for example BUTYL CYCLOHEXYL ACETATE PARA), 2-(4-methylcyclohexyl)propan-2-yl acetate (for example MENTHANYL ACETATE), benzyl 2-hydroxybenzoate (for example BENZYL SALICYLATE), (4E)-9-hydroxy-5,9-dimethyl-4-decenal (for example MAHONIAL™), 2-cyclohexylidene-2-phenylacetonitrile (for example PEONILE), 2-hexylcyclopent-2-enone (for example ISOJASMONE T™), 1-(2-naphtalenyl)-ethanone (for example ORANGER CRYSTALS), 2,2,2-trichloro-1-phenylethyl acetate (for example ROSACETOL™), 3-(benzo[d][1,3]dioxol-5-yl)-2-methylpropanal (for example TROPIONAL), hexyl 2-hydroxybenzoate (for example HEXYL SALICYLATE); (4Z)-hept-4-en-2-yl 2-hydroxybenzoate (for example KARMAFLOR™), 3-(4-isobutyl-2-methylphenyl)propanal (for example NYMPHEAL), 3-methyl-5-phenylpentan-1-ol (for example MEFROSOL™), (Z)-6-(pent-2-en-1-yl)tetrahydro-2H-pyran-2-one (for example JASMIN LACTONE DELTA), 3-(4-(tert-butyl)phenyl)-2-methylpropanal (for example LILIAL™), (E)-3-phenylprop-2-en-1-ol (for example CINNAMIC ALCOHOL), 2-methoxynaphthalene (for example YARA YARA), (4-methoxyphenyl) methanol (for example ANISYL ALCOHOL), 2-ethoxynaphthalene (for example NEROLINE™ CRYSTALS), 2,2-dimethyl-3-(m-tolyl)propan-1-ol (for example MAJANTOL™), 7,9-dimethylspiro[5.5]undecan-3-one (for example DISPIRONE), 3-(4-(tert-butyl)phenyl)propanal (for example BOURGEONAL™), (E)-4-((3aS,7aS)-hexahydro-1H-4,7-methanoinden-5(6H)-ylidene) butanal (for example DUPICAL™), pentyl 2-hydroxybenzoate (for example AMYL SALICYLATE), (E)-4-(2,5,6,6-tetramethylcyclohex-2-en-1-yl) but-3-en-2-one (for example IRONE ALPHA™, 3-(4-isopropylphenyl)-2-methylpropanal (for example CYCLAMEN™ ALDEHYDE), 4-(4-methylpent-3-en-1-yl)cyclohex-3-enecarbaldehyde (for example MYRALDENE™), dec-9-en-1-ol (for example ROSALVA™), (1-methyl-2-(5-methylhex-4-en-2-yl)cyclopropyl) methanol (for example ROSYFOLIA™), 3-(3-isopropylphenyl) butanal (for example FLORHYDRAL™), 3-phenylpropan-1-ol (for example PHENYL PROPYL ALCOHOL), 2-methyl-4-phenylbutan-2-ol (for example DIMETHYL PHENYL ETHYL CARBINOL), methyl 2-aminobenzoate (for example METHYL ANTHRANILATE), tetrahydro-4-methyl-2-(2-methylpropyl)-2H-pyran-4-ol (for example FLOROSA™); 3-(4-ethylphenyl)-2,2-dimethylpropanal (for example FLORALOZONE™), methyl 2-(methylamino)benzoate (for example DIMETHYL ANTHRANILATE), (E)-3,7-dimethylocta-2,6-dien-1-ol (for example GERANIOL™), (E)-4-(2,6,6-trimethylcyclohex-1-en-1-yl) but-3-en-2-one (for example IONONE BETA), 3,7-dimethyloct-6-en-1-ol (for example CITRONELLOL), 4-(2,6,6-trimethylcyclohex-1-en-1-yl) butan-2-one (for example DIHYDRO IONONE BETA), (E)-3-methyl-4-(2,6,6-trimethylcyclohex-2-en-1-yl) but-3-en-2-one (for example ISORALDEINE 70™), 4-cyclohexyl-2-methylbutan-2-ol (for example CORANOL), (Z)-3-methyl-2-(pent-2-en-1-yl)cyclopent-2-enone (for example JASMONE™ CIS, 3-phenylprop-2-enyl 3-phenylprop-2-enoate (for example CINNAMYL CINNAMATE), 4-formyl-2-methoxyphenyl isobutanoate (for example ISOBUTAVAN™), 3-ethoxy-4-hydroxybenzaldehyde (for example ETHYL VANILLIN), 2H-chromen-2-one (for example COUMARIN™), 3-hydroxy-2-methyl-4H-pyran-4-one (for example MALTOL™), 2-ethyl-3-hydroxy-4H-pyran-4-one (for example ETHYL MALTOL™); (E)-2-methoxy-4-(prop-1-en-1-yl) phenol (for example ISOEUGENOL), 4-allyl-2-methoxyphenyl acetate (for example EUGENYL ACETATE), (E)-1,2-dimethoxy-4-(prop-1-en-1-yl)benzene (for example METHYL ISOEUGENOL), octahydro-2H-chromen-2-one (for example BICYCLO NONALACTONE), benzo[d][1,3]dioxole-5-carbaldehyde (for example HELIOTROPINE™); 2-methoxy-4-propylphenol (for example DIHYDRO EUGENOL), (E)-3-phenylprop-2-enenitrile (for example CINNAMALVA™), 4-allyl-2-methoxyphenol (for example EUGENOL), (2E)-3-phenylprop-2-enal (for example CINNAMIC ALDEHYDE); (Z)-cycloheptadec-9-enone (for example CIVETTONE™), 1,4-dioxacycloheptadecane-5,17-dione (for example ETHYLENE BRASSYLATE), 1,4-dioxacyclohexadecane-5,16-dione (for example MUSK C14), 4,6,6,7,8,8-hexamethyl-1,3,4,6,7,8-hexahydrocyclopenta[g]isochromene (for example GALAXOLIDE™), (Z)-oxacycloheptadec-10-en-2-one (for example AMBRETTOLIDE™), 2-(1-(3,3-dimethylcyclohexyl) ethoxy)-2-methylpropyl cyclopropanecarboxylate (for example SERENOLIDE™), 1-oxacycloheptadecan-2-one (for example DIHYDRO AMBRETTOLIDE), (E)-oxacyclohexadec-12-en-2-one (for example HABANOLIDE™), (Z)-cyclohexadec-5-enone (for example VELVIONE™), cyclopentadecanone (for example MUSK CPD), (Z)-3-methylcyclopentadec-5-enone (for example MUSCENONE™), oxacyclohexadecan-2-one (for example THIBETOLIDE™), (Z)-3-methylcyclotetradec-5-enone (for example COSMONE™), (E)-13-methyloxacyclopentadec-10-en-2-one (for example NIRVANOLIDE™); (E)-2-((3,5-dimethylhex-3-en-2-yl)oxy)-2-methylpropyl cyclopropanecarboxylate (for example SYLKOLIDE™), 1a,3,3,4,6,6-hexamethyl-1a,2,3,4,5,6,7,7a-octahydronaphtho[2,3-b]oxirene (for example MOXALONE™), 1,1,2,3,3-pentamethyl-2,3,6,7-tetrahydro-1H-inden-4(5H)-one (for example CASHMERAN™); 4-(4-hydroxyphenyl) butan-2-one (for example RASPBERRY KETONE), 6-heptyltetrahydro-2H-pyran-2-one (for example DODECALACTONE DELTA), 5-octyloxolan-2-one (for example DODECALACTONE GAMMA), 6-hexyltetrahydro-2H-pyran-2-one (for example UNDECALACTONE DELTA); 6-pentyltetrahydro-2H-pyran-2-one (for example DECALACTONE DELTA), 5-hexyloxolan-2-one (for example DECALACTONE GAMMA), ethyl methyl phenyl glycidate (for example STRAWBERRY), 4-methyl-5-pentyldihydrofuran-2(3H)-one (for example METHYL TUBERATE); ethyl 6-acetoxyhexanoate (for example BERRYFLOR), 5-pentyldihydrofuran-2(3H)-one (for example PRUNOLIDE™), 2-methyl-1-phenylpropan-2-yl butanoate (for example DIMETHYL BENZYL CARBINYL BUTYRATE), 6-propyltetrahydro-2H-pyran-2-one (for example OCTALACTONE DELTA), (E)-1-(2,6,6-trimethylcyclohex-1-en-1-yl) but-2-en-1-one (for example DAMASCONE BETA); (E)-1-(2,6,6-trimethylcyclohex-2-en-1-yl) but-2-en-1-one (for example DAMASCONE ALPHA); (E)-1-(2,6,6-trimethylcyclohex-3-en-1-yl) but-2-en-1-one (for example DAMASCONE DELTA); (2E,6Z)-3,7,11-trimethyldodeca-2,6,10-trien-1-ol (for example FARNESOL™), 2-phenethyl 2-hydroxybenzoate (for example PHENYL ETHYL SALICYLATE CRYSTALS), (E)-2-benzylideneoctanal (for example ALPHA HEXYL CINNAMIC ALDEHYDE), diphenylmethanone (for example BENZOPHENONE), methyl 3-oxo-2-pentylcyclopentaneacetate (for example HEDIONE™), (3E,6E)-2,4,4,7-tetramethylnona-6,8-dien-3-one oxime (for example LABIENOXIME™), 3-(benzo[d][1,3]dioxol-5-yl)-2-methylpropanal (for example TROPIONAL™); (E)-tridec-2-enenitrile (for example TRIDECENE-2-NITRILE), 3-(4-methoxyphenyl)-2-methylpropanal (for example FENNALDEHYDE™), (E)-6,10-dimethylundeca-5,9-dien-2-yl acetate (for example TANGERINOL™), 6-butan-2-yl-quinoline (for example ISOBUTYL QUINOLINE), 2,6,10-trimethylundec-9-enal (for example ADOXAL™), 7-methyl-2H-benzo[b][1,4]dioxepin-3(4H)-one (for example CALONE 1951™); dodecanenitrile (for example CLONAL™), 4,4a,5,9b-tetrahydroindeno[1,2-d][1,3]dioxine (for example INDOFLOR™), 2-cyclohexylhepta-1,6-dien-3-one (for example PHARAONE™), decan-1-ol (for example ALCOHOL C 10 DECYLIC), 8-(sec-butyl)-5,6,7,8-tetrahydroquinoline (for example BIGARYL™), methyl 3-phenylprop-2-enoate (for example METHYL CINNAMATE), (E)-undec-9-enenitrile (for example FLORIDILE); (E)-7,11-dimethyl-3-methylenedodeca-1,6,10-triene (for example FARNESENE™), (3aR,6S,7aS)-3a,4,5,6,7,7a-hexahydro-1H-4,7-methanoinden-6-yl propionate (for example FLOROCYCLENE™), 4-(tert-butyl)cyclohexanol (for example BUTYL CYCLOHEXANOL PARA), 1-(3,3-dimethylcyclohex-1-en-1-yl) pent-4-en-1-one (for example GALBANONE™), dodecanal (for example ALDEHYDE C 12 LAURIC), 2-isopropyl-5-methylphenol (for example THYMOL CRYSTALS), (E)-3-phenylprop-2-en-1-ol (for example CINNAMIC ALCOHOL), allyl 3-cyclohexylpropionate (for example ALLYL CYCLOHEXYL PROPIONATE), diphenylmethane (for example DIPHENYL METHANE), (E)-4-methyldec-3-en-5-ol (for example UNDECAVERTOL™); and mixtures thereof.

It will be understood that the boundaries between the three categories top, middle and base notes are not rigidly defined, and some interpretations would place some ingredients in a different class.

The weight proportion of fragrance in the finished litter is from 0.01%-5%, more particularly from 0.05-2.5% and most particularly from 0.09-1.5%.

In addition to the matrix material and the fragrance, there can also be added to the litter auxiliary ingredients that are well known to the art of litter manufacture. These include auxiliary binding materials such as guar gum, xanthan gum, carrageenan and locust bean gum. These may be present in a weight proportion up to 5% by weight of the litter. Preservatives may also be included. Any of the art-recognized preservatives and anti-bacterial agents may be used, for example, sodium benzoate, persimmon tannins, enzymes such as Prefur™, typically at a level of from 0.05-1.5% by weight of the total litter.

The litter is prepared by first preparing the fragranced particulate material, by blending fragrance and matrix material. This is then added to the animal litter base mixing all ingredients, adding sufficient water to allow extrusion and then granulating the extruded material to a desired size, typically in the range of from 0.2-0.3 mm in diameter and 0.5-1.5 cm in length. The granulated material is then heated in an oven, typically at 120° C. for 30 minutes, in order to remove the water and produce a finished litter.

The animal litter prepared as described hereinabove has unusually long-lasting fragrance and malodour suppression properties.

The disclosure is now further described with reference to the following examples, which depict particular embodiments and which are not meant to be in any way limiting. All proportions are by weight.

### Example 1

### (a) Formulation of Fragrance:

A fragrance was formulated according to the following formula:

| No. | Ingredient | Percentage (%) |
|---|---|---|
| 1 | ACETOIN CRIST | 20 |
| 2 | BUTYRATE ETHYLE | 15 |
| 3 | CAPRYLATE ETHYLE | 15 |
| 4 | DECALACTONE DELTA | 5 |
| 5 | DECALACTONE BENZYLE | 3 |
| 6 | BENZOATE BENZYLE | 1 |
| 7 | ETHYL MALTOL | 16 |
| 8 | ETHYL VANILLINE | 14 |
| 7 | HYDROXY ETHYL METHYL THIAZOL | 1 |
| 8 | OCTALACTONE GAMMA | 5 |
| 9 | PRUNOLIDE ™ | 5 |
| TOTAL | | 100 |

This formula had 50% top note ingredients, 40% middle note ingredients and 10% base note ingredients. The proportion of top note ingredients having a flash point below 150° C. and vapour pressure above 0.2 ug/L was 100%

### (b) Preparation of Particulate Matrix Material

The following materials were used:

| | |
|---|---|
| Fragrance (from (a) above) | 30% |
| Talcum powder | 20% |
| Aerosil ™ 200 fumed silica | 50% |

The talcum powder was added to a mixing vessel and the fragrance sprayed on to it with stirring. The fumed silica was then added, and the mixture stirred well and allowed to age overnight before use.

(c) Preparation of Cat Litter with Perfumed Particulate Matrix Material

The cat litter base consisted of pea fiber, corn starch (CAS 9005-25-8), maize powder (CAS 68525-86-0) and guar gum (CAS 9000-30-0).

The proportions of the cat litter were as follows:

| | |
|---|---|
| pea fiber | 36% |
| corn starch | 27% |
| maize powder | 22.5% |
| guar gum | 4.32% |
| sodium benzoate | 0.09% |
| fragranced particulate matrix material | 0.09% |

(from (c) above)

To this blend in a mixer was added 10% water, the mixture was thoroughly blended, extruded and granulated. The extruded product was transferred to an oven and heated at 120° C. for 30 minutes to evaporate the water from the cat litter. The dried material was sieved to provide a product of particle size of 0.2-0.3 mm diameter and 1-1.5 cm length.

(d) Preparation of Litter with Normal Fragrance

The abovementioned litter preparation was repeated with the fragrance (a) being replaced by an equal proportion of a normally-formulated fragrance, having a top/middle/base note weight ratio of 20/50/30.

### (e) Comparison of Litters

The comparison was effected between the litters (c) and (d) above and a sample of the litter base without any fragrance.

In each case, the samples were tested by a panel of trained testers, who rated the samples on a scale of 0 (no malodour) to 5 (strong malodour) for malodor strength and a scale of 0 (no fragrance) to 5 (strong fragrance) for fragrance strength.

### Urine Malodour Test

50 g of the three litters prepared were treated by injecting into them 800 μl of a commercially-available synthetic urine malodor. They were then evaluated, as described hereinabove.

10 g deionized water was then added to each litter and they were shaken for 10 times to clump the base. The litters were aged for 2 minutes before rating the malodor strength and fragrance strength again.

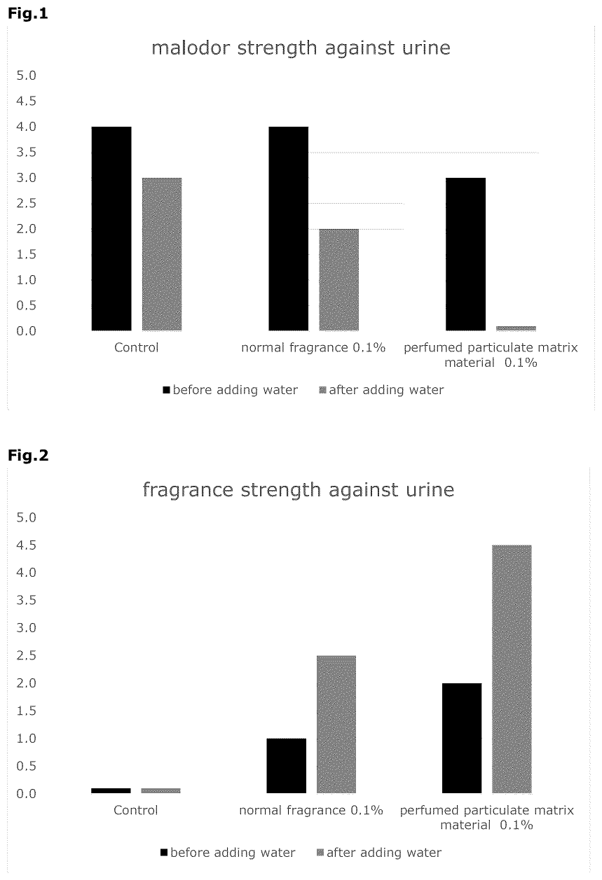

The results are shown graphically in FIGS. 1 and 2, respectively.

### Fecal Malodour Test

The procedure described above for the urine malodour test was repeated with 50 g of the three litters being injected with 100 μl of a commercially-available standard synthetic fecal malodor as malodor source.

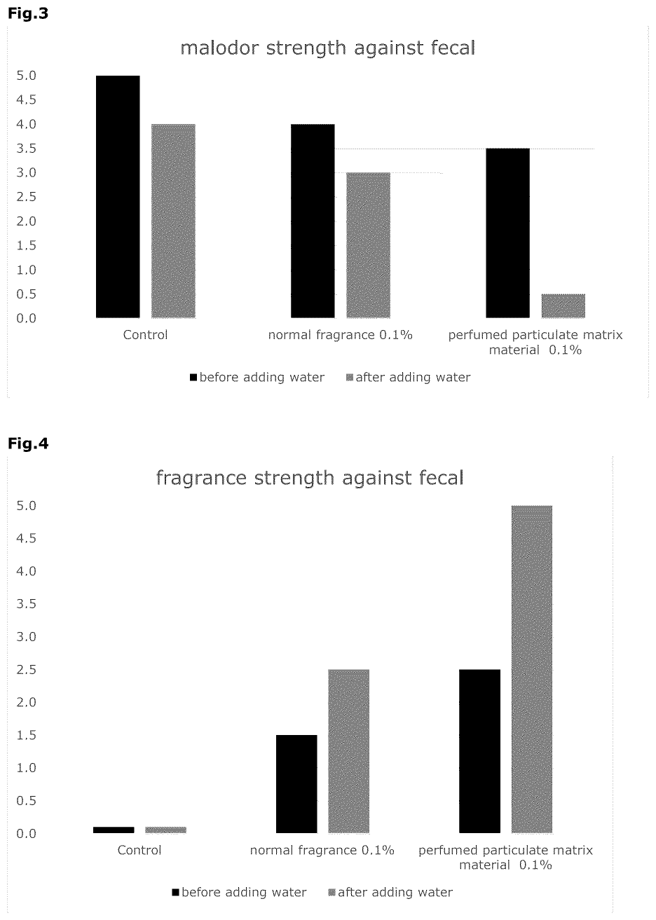

The results are shown in FIGS. 3 and 4 respectively.

It can clearly be seen that the use of a fragrance formulated as hereinabove described incorporated in a particulate matrix gives superior malodour suppression results.

1. An animal litter comprising (a) an animal litter base and (b) a particulate absorptive matrix to which fragrance has been added, the fragrance being characterised by (a) having weight proportions of top, middle and base notes of respectively 35-80, 10-40 and 5-25% (b), components with a C log P value of less than 1.5 comprising 3% maximum of the fragrance, and (c) being substantially free from water-miscible solvents.

2. The animal litter according to claim 1, in which weight proportions of top, middle and base notes are respectively 40-70, 15-35 and 8-20%.

3. The animal litter according to claim 1, in which at least 50% by weight of the top note ingredients have a flash point below 150° C. and a vapor pressure above 0.2 ug/L.

4. The animal litter according to claim 3, in which 100% by weight of the top note ingredients have a flash point below 150° C. and a vapor pressure above 0.2 ug/L.

5. The animal litter according to claim 1, in which the weight proportion of fragrance in the finished litter is from 0.01%-5%.

6. A method of preparing an animal litter comprising a malodour-counteracting fragrance, comprising the steps of blending animal litter base, particulate absorptive matrix and fragrance components, adding sufficient water to permit extrusion, extruding the mixture, granulating the mixture, and drying the granulates, characterised in that the fragrance is added in the form of the particulate absorptive matrix according to claim 1.

7. The animal litter according to claim 2, in which weight proportions of top, middle and base notes are respectively 45-60%, 25-35% and 10-20%.

8. The animal litter according to claim 2, in which weight proportions of top, middle and base notes are respectively 50-60, 25-30% and 10-15%.

9. The animal litter according to claim 1, in which the weight proportion of fragrance in the finished litter is from 0.05-2.5%.

10. The animal litter according to claim 1, in which the weight proportion of fragrance in the finished litter is from 0.09-1.5%.

11. The animal litter according to claim 1, further comprising a litter auxiliary ingredient.

12. The animal litter according to claim 11, wherein the litter auxiliary ingredient comprises a litter auxiliary binding material selected from guar gum, xanthan gum, locust bean gum and carrageenan in an amount up to 5% by weight of the animal litter.

13. The animal litter according to claim 11, wherein the litter auxiliary ingredient comprises a preservative selected from sodium benzoate, persimmon tannins, and enzymes in an amount from 0.05-1.5% by weight of the animal litter.

14. The method of claim 6, wherein the size of the granulates is 0.2-0.3 mm in diameter and 0.5-1.5 in length.

15. The method of claim 6, wherein the heating step is 120° C. for 30 minutes.
